(19) United States
(12) Patent Application Publication
(10) Pub. No.: US 2018/0005763 A1
(43) Pub. Date: Jan. 4, 2018

(54) ELECTRODE FOR PHOTOELECTRIC CATALYSIS, SOLAR CELL, AND METHOD FOR PRODUCING SAID ELECTRODE

(71) Applicant: Technische Universität Berlin, Berlin (DE)

(72) Inventors: Michael LUBLOW, Berlin (DE); Anna FISCHER, Berlin (DE); Matthias DRIESS, Berlin (DE); Johannes PFROMMER, Berlin (DE); Thomas SCHEDEL-NIEDRIG, Kleinmachnow (DE); Michael KANIS, Berlin (DE); Anahita AZARPIRA, Berlin (DE)

(21) Appl. No.: 15/543,201

(22) PCT Filed: Jan. 21, 2016
(86) PCT No.: PCT/EP2016/051193

§ 371 Date: Jul. 12, 2017

(30) Foreign Application Priority Data
Jan. 21, 2015 (DE) 10 2015 200 958.0

(51) Int. Cl. H01G 9/20; C09C 1/00

(52) U.S. Cl. CPC H01G 9/2027; H01G 9/2022; C09C 1/0006; C01P 2006/40; C01P 2002/85

(57) ABSTRACT

The invention relates to an electrode (10) for photoelectric catalysis, comprising a supporting layer (1) on which a catalytic layer (2) is arranged, which comprises particles (3) from a first semiconductor material, and a method for the production of said electrode and a solar cell with said electrode.

It is provided that the catalytic layer (2) further features a matrix (4) consisting of a second semiconductor material, which at least partially surrounds the particles.

The invention relates to an electrode for photoelectric catalysis, comprising particles from a semiconductor material and a solar cell with such an electrode, and a method for producing said electrode.

Photocatalytic electrodes feature a surface which is photoactive, i.e. its material generates electron-hole pairs as a result of an internal photo effect through light excitation. Consequently, due to the illumination, the conductivity and the overvoltage required for a reaction of a reaction to be catalyzed is reduced.

Photocatalytic electrodes are used for example with (photo)electrochemical water splitting (H₂O→H₂+1/2O₂) to obtain alternative fuels or with the reaction of carbon dioxide with carbon monoxide or hydrocarbons with a low oxidation number.

Such photocatalytic electrodes can for example be produced using electrophoretic deposition (EPD) of pigment powders on a substrate surface (support). The electrophoretic deposition is a widely used industrial process in which colloidal particles are deposited on an electrode under the influence of an electric field.

The electrophoretic deposition of photoactive materials in powder form, which have been synthesised in the laboratory, is the prior art. The best-known example of recent research is the deposition of tantalum oxide (TaON) on conductive substrates. Other areas of work in which an electrophoretic method has been used include the production of non-photoactive films made of materials such as yttrium or cer-based oxides.

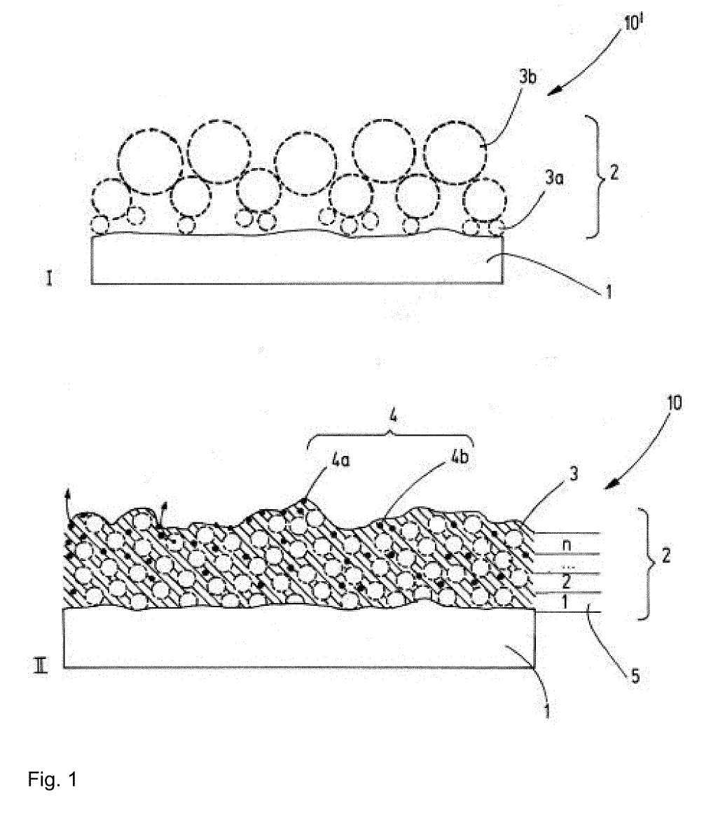

The particles to be deposited are mostly particles that are produced on a laboratory scale in order to meet the high quality standards. In order to represent high-quality electrodes, high standards are in particular set for a low variation in particle size and in their material properties such as defect density on the particle surface. Particles, particularly pigment particles, from industrial production do not meet these standards, since they are prepared as pigment powders which feature a relatively broad variation in particle size. The use of such powders in the production of electrodes using EPD leads to electrodes which feature a non-homogeneous distribution of particles in the catalytic layer (FIG. 1). This is due to the fact that during the EPD, smaller particles are deposited faster on the substrate surface than larger particles due to the low flow resistances.

Additionally, materials available industrially feature a large number of defect sites, which leads to a high recombination rate in the material and on the surface of the particles, and considerably reduces the quality of the electrodes.

The production of (pigment) particles of a high quality before EPD requires a high level of effort and costs, however, so that one object of the invention is to provide a low-cost, high-quality electrode and a low-cost method for producing said electrode.

This object is attained by means of an electrode and a method with the features described in the independent claims.

Thus, a first aspect of the invention relates to an electrode for photoelectric catalysis, comprising a supporting layer on which a catalytic layer is arranged which comprises particles from a first semiconductor material. According to the invention, the catalytic layer further features a matrix that comprises a second semiconductor material. This matrix is arranged in such a manner that it at least partially surrounds (embeds) the particles.

The advantage of the electrode according to the invention is in particular that the matrix facilitates a removal of the charge carriers generated by the photo effect and separated by the particle-matrix interface, and thus inhibits a recombination of the separated charge carriers on the particle surface. In this way, the conductivity of the material is retained when irradiated with light over longer distances than with standard materials, in which a charge carrier migration only takes place over adjacent particles. Consequently, with the electrodes according to the invention, a high quality and in particular under irradiation a higher photoelectric current or a higher photoelectric voltage is obtained.

This effect is further enhanced the fewer the number of particles that feature areas in which they have no contact with either other particles or the matrix. Thus it is particularly preferred that the matrix surrounds the particles on all sides, and that the particles are embedded in the matrix material, as it were.

In the present method, a photoelectric electrode is regarded as being both a photoelectrochemical and a photovoltaic electrode. The photoelectrochemical electrode is here arranged on an electrolyte which together with the electrode forms an electrochemical half cell, while in contrast, the photovoltaic electrode borders on an ion conductor which in particular comprises a redox pair, and due to the photovoltaic reaction is not used.

Photoelectrochemical cells, or PECs, are solar cells https://de.wikipedia.org/wiki/Solarzelle and convert visible light into electrical energy. A cell consists of a semiconductor photoanode, a cathode made of metal and an electrolyte. The cells either directly generate electrical energy or they produce hydrogen in a process similar to the electrolysis of water.

The supporting layer is an electrically conductive material on which the catalytic layer is arranged. The supporting layer in particular defines the outer form and size of the electrode and can be connected to an electric circuit.

The catalytic layer comprises particles and a matrix and is photoactive. This means that preferably, both the particles and the matrix show an inner photo effect, in particular photoconductivity. Thus, the catalytic layer is designed in particular to catalyze reactions electrochemically.

The particles are preferably pigment particles, in particular color pigment particles. The pigments feature photoactive properties and are not soluble in the application medium used, such as a solvent (DIN 55944). The particles comprise a semiconductor material which preferably comprises at least one metal or one metal ion.

The electrodes are preferably flat electrodes with which the overvoltages required for the reaction (e.g. for the oxidation of water) are reduced by the photoactivity of the catalytic layer, in particular the pigments. This reduction is enabled by the inner photo effect of the particles with the light-exciting generation of electron-hole pairs, i.e. a photovoltage is built up which does not need to be fed by an external voltage source, and thus permits electrode reactions with lower overall voltages. The current densities that occur here are carried by charge carriers (electrons with a reduction reaction or holes with an oxidation reaction) which are solely or mostly light induced, i.e. they do not occur if there is no illumination.

In one preferred embodiment of the electrode according to the invention, it is provided that at least 90% of the particles feature a deviation from an average particle diameter of maximum 20%, in particular of maximum 15%, preferably a maximum of 10%, i.e. the particles are distributed in a monodispersed manner. Advantageously, this embodiment ensures that the electrode, and/or the catalytic layer of the electrode, features the same electrochemical, in particular electrical properties in all sections and/or partial sections.

A collection of particles or individual parts with the same properties (physical, chemical or organic) is described as “monodisperse”. Only one property can also be the same, depending on the permissible standard deviation, application or size classes. Here, the dispersion refers in particular to the composition and/or diameter of the particles.

The average particle diameter has a direct influence on the quality of the electrode, alongside the distribution of the particle diameters. Preferably, the particles are nanoparticles. The average particle diameter is as small as possible and preferably lies in a range of 50 to 100 nm. One preferred particle diameter is dependent on the material and lies in a range of a free diffusion length of the charge carrier in the particle material, since this ensures a long service life τ of the light-excited charge carriers.

The service life τ of the light-excited charge carriers, i.e. the time duration over which the electron hole-pairs exist in a separated state, indicates the time period for which the charge carriers can be used for the electrode reaction before they recombine (in the particle volume) and are thus no longer available for a reaction on the solid body-electrolyte interface.

In a similar manner to the service life, according to the invention, the quality of the electrode can also be described by what is known as the (minority charge carrier) diffusion length, L_{P}, i.e. the length scale over which the separated charge carriers can move before a recombination occurs. There is a mathematical connection between these two values when what is known as the diffusion coefficient Dₚ is used, via: Lₚ=(Dₚτ)^{1/2}

In the simplified Gartner model, the anticipated photoelectric current density can ultimately be represented with these material constants in a simplified manner, depending on the light intensity I₀, the light absorption coefficient α and the electronic band deflection in the material W which is dependent (on the surrounding electrolyte) via:

jₚₕₒₜₒ=−eI₀(1−e^{-aW}/(1+αLₚ)).

Thus, it is preferred that the particles comprise a material that features a particularly high diffusion length Lₚ of the minority charge carrier.

Further, the density of electronic defects in the volume of the particles and/or on their surface is preferably as low as possible, since these accelerate the recombination of the separated charge carriers in the volume and lead to an increased charge carrier combination on the surface.

In a further preferred embodiment of the invention, it is provided that the semiconductor materials feature free charge carriers, wherein the type of charge carriers that represent a majority (majority charge carriers) in the matrix material corresponds to the type of charge carriers that subsequently form as a result of the illumination in the particles (minority charge carriers). In this embodiment, a removal of the light-generated charge carriers over the matrix material to the electrolyte interface is optimized.

The matrix material is in particular an amorphous material which surrounds the particles and permits a removal of light-generated charge carriers to the electrolyte interface. The electronic structure of this matrix material is preferably characterized in that the minority charge carrier type within the particles (light-excited electrons or holes) is congruent with the majority charge carrier type in the matrix material. This means, for example, that within the particles, holes (known as defect electrodes) are excited by light and after transport to the particle-matrix interface are forwarded from there via a hole current within the matrix material until they reach the interface to the electrolyte. Since in this example it has been assumed that the holes are majority charge carriers in the matrix material, i.e. they are not light-excited, the recombination probability within the matrix material is very low. The above example is, according to a characterization via the doping type, realized by a combination of n-doped particles with a p-doped matrix material. Alternatively, the majority charge carriers of the matrix material as a result of doping, and the minority charge carriers, i.e. the charge carriers that are solely light-excited, of the particles are electrons.

Further, it is preferred when the cations of the matrix material comprise the same elements as the cations of the material of the particles. In a particularly preferred manner, the matrix material hereby comprises oxides and/or ceramics at least of one type of cation of the particle composition.

Further, it is preferred that the matrix material comprises a base material alongside the amorphous semiconductor material, which is rich in carbon and is both electronically and electrochemically inert. The carbon share is preferably higher than 30 weight %, in particular higher than 45 weight %, and particularly preferred higher than 50 weight %. Such a matrix material is used among other things to protect the photoactive particles, which would otherwise be amorphized on direct contact with the electrolytes through oxidation and reduction processes, and thus lose their photoactivity, or least strongly reduce it, due to an increased number of recombination processes.

In a further preferred embodiment of the electrode according to the invention, the catalytic layer is designed as a multilayer system of a plurality of layers according to the invention of a similar type. This has the advantage that the catalytic layer is very homogeneous in a defined layer thickness, since thin layers of the same type achieve maximum homogeneity due to their reduced layer thickness, and the stringing together to form a thicker layer of a defined layer thickness leads to a layer that also has maximum homogeneity. Furthermore, due to the arrangement of heterogeneous layers to form a multilayer system, a catalytic layer is achieved which for example features a gradient in relation to the conductivity in relation to the layer thickness. Preferably, here 2 to 10, in particular 2 to 5, layers are arranged.

A further aspect of the invention relates to a solar cell which features an electrode according to the invention. The advantage of a solar cell according to the invention is in particular that the solar cell according to the invention is simpler to make, has a longer service life and can be constructed from non-toxic substances. In the solar cell according to the invention, the electrode forms the absorber material. An ion conductor, which is in particular fixed, is arranged on the electrode.

The solar cell further features a counter-electrode, which is connected electrically via the ion conductor to the electrode according to the invention (photoelectrode). The counter-electrode is preferably flat and is arranged opposite the electrode according to the invention in such a manner that a layer stack is created from photoelectric electrodes according to the invention (absorber material of the solar cell)/ion conductors/counter-electrodes. In this embodiment, the counter-electrode preferably comprises a transparent and electrically conductive material (TCO) for the active wavelengths of the photoelectric electrodes (those which trigger a photo effect in the photoelectrode). The advantage of this embodiment is in particular that due to the large surface and the parallel arrangement of the electrodes, a large number of generated free charge carriers can be captured without these traveling a long distance in the ion conductor and recombining. This increases the degree of efficiency. Alternatively, the counter-electrode is a rod or platelet electrode. The advantage of this embodiment is that shading can be entirely prevented. Additionally, depending on the material, the recombination rate of free charge carriers is reduced due to a smaller surface.

If in the photoelectrode charge carriers are generated as a result of the irradiation due to a photo effect, these are separated and guided via the ion conductor to the counter-electrode, in order to be fed into an external power circuit.

A further aspect of the invention relates to a method for producing electrodes for photoelectric catalysis, in particular those described above. According to the invention, the method comprises at least the following steps:
a: Preparing a suspension of particles in a solvent and bringing the suspension into contact with a supporting layer,
b: Applying a voltage pulse between the supporting layer and the suspension for depositing a layer of particles on the supporting layer, and
c: Reducing the diameter of the suspended particles, wherein step b is repeated.

The method of functioning of the method according to the invention consists in particular of the fact that a migration of charged particles is initiated to the surface only for the duration of a short voltage pulse, only for this short period of time. Due to flow resistances, only the smallest particles are able to reach the surface within the voltage pulse and be deposited. Particles that feature a particle diameter above a certain value remain in suspension and are not deposited. The etching of the particles in turn generates small particles again through the reduction in size of the particles, which are deposited in a next voltage pulse. Thus, a very homogeneous layer is deposited, the deposited particles of which do not exceed a certain diameter without it being a precondition that such homogeneously distributed particles should already be made available as a suspension.

The method according to the invention illustrates the advantage that on the one hand, the particle diameter is strongly reduced in size in relation to the initial material in order to reduce the so-called volume recombination rate of the light-generated charge carriers, and further that compared to standard methods, the effort and costs of preparing the particles are considerably reduced, since quality level required of the particles is lower than in standard methods. Thus, with the method according to the invention, particles can be used with a greater variance in particle diameter, since these are reduced in step c. Additionally, the quality of the particle surface in step c is optimized, whereby the defect density on the surface is reduced. Through the deposition of the small particles in step b, it is achieved that only particles that lead to a high-quality catalytic layer are deposited on the carrier material.

In relation to the costs, the use of industrially produced and commercially available particles leads to a considerable reduction, since low-cost particles of low quality can be used as starting materials for the deposition. At the same time, the quality of the electrodes is increased, i.e. the achievable photovoltage and photocurrent densities are maximized. Here, it is of particular significance that electrodes can be produced from particles that are usually of low quality (compared to those materials produced for research purposes in the laboratory), which initially show only detectable photoactivity and—in a subsequent optimization step—achieve an efficiency that is of technical-industrial application relevance. Usually, these include photoelectrocatalytic current densities of approximately 10 mAcm⁻² under AM1.5 lighting conditions directly on the thermodynamic potential of the observed reaction.

According to the invention, a method is recommended for generating a heterosystem by means of which pigment particles, which are preferably crystalline, with an average diameter of a similar size to the material-specific diffusion length or below are embedded at least partially, preferably fully, in an amorphous conductive (e.g. oxidic) matrix. The matrix material is here preferably obtained from the particles. Through multi-stage, combined processing, which includes electrophoretic particle transportation and the simultaneous formation of an amorphous matrix material, a heterogeneous structure of the electrodes is achieved. Here, processing preferably occurs in two to ten steps, preferably two to five steps; in other words, step b and/or step c is repeated two to ten, preferably two to five times.

In step a, according to the method according to the invention, particles to be deposited are suspended in a suitable solvent. A suitable solvent is one which does not dissolve the particles, although preferably prevents a cohesion of the particles in the manner of a suspension. Depending on the particle material selected, these are preferably protic solvents. The suspended particles feature a polarized or ionized surface. Further, step a comprises the bringing into contact of the carrier material with the suspension, which is understood as including, for example, immersion of the carrier material into the suspension, but application of the suspension on the carrier material. The carrier material here comprises a surface on which the particles are deposited during the course of the method.

The polarization or ionization of the surface of the particles is preferably achieved through the addition of a chemical additive. Preferably, the charge of the particle surface is determined by the addition of an oxidation or reduction agent to the suspension. One preferred reagent is iodine, for example.

The subsequent step b comprises the application of a voltage pulse, i.e. the application of a voltage at a prespecified level for a prespecified, in particular brief, time period. Here, time periods of several seconds to a few minutes are regarded as being brief. No voltage, or a voltage that is low compared to the voltage pulse, is applied between two voltage pulses.

The voltage is polarized in such a way that an electric field is induced, which causes the particles to migrate within the suspension to the surface of the carrier material due to their polarized or ionized surface. Depending on the charge on the particle surface, the voltage is applied in such a manner that the carrier material is a positive or negative electric pole. The migration speed is in particular determined by the viscosity of the solvent and the particle diameter, particles with a smaller diameter feature a higher migration speed than those with a larger particle diameter and/or a larger particle surface. After the end of the voltage pulse, the migration of the particles is interrupted after only a portion of the suspended particles, namely those with a smaller diameter and/or the smaller surface, have reached the surface of the carrier material and are deposited there.

The duration of the voltage pulse thus has an influence on the layer thickness and layer composition deposited with each voltage pulse, and in particular the maximum particle diameter within the deposited layer.

In a preferred embodiment of the method according to the invention, it is provided that the voltage pulse is applied for a time duration of 10 seconds to 5 minutes, preferably from 1 to 3 minutes, in particular from 1 to 2 minutes. Within the preferred time durations, the deposited layer features a large homogeneity of the particle sizes. Further, within these time durations, it is ensured that the deposited particles feature a diameter that is smaller than or equal to the diffusion length Lₚ of the charge carrier within the particle material. As described above, electrodes with such layers feature a particularly high quality.

In step c of the method according to the invention, a reduction of the particle diameter occurs. In one preferred embodiment, this reduction occurs through chemical etching. For this purpose, at the beginning of the method and/or during the method, then preferably between the voltage pulses, a chemical etching agent is added to the suspension. The chemical etching agent is characterized by the fact that it can fundamentally dissolve the particle material, but that this occurs with such speed that during the method, only a portion of the particles, in particular a portion of the individual particles, dissolves.

Preferably, the suspension is supplemented with lyes or alkalies for the purpose of etching. Alternatively or in addition, however, other reagents such as oxidation and reduction agents can be added which transfer the particle material into substances which are then soluble in the solvent. The latter dissociate in preferably protic solvents. For example, the addition of iodine to the suspension initially leads to a charged particle surface. Excessive iodine forms iodine hydrogen acid (HI) which then acts as an etching agent during the further course of the reaction.

The reduction in diameter of the particles can also take place during the voltage pulse, in addition to step c, i.e. essentially continuously. This is realized, for example, by the fact that a chemical etching agent is present in the suspension during the entire procedure.

When reducing the diameter of the particles, a portion of the surface of the particles is dissolved. As a result, on the one hand, a reduction of the particle diameter occurs. On the other, the dissolved substance is then able to also enter into further compounds such as oxides, and to also be deposited as matrix material on the surface. This deposition occurs simultaneously with the deposition of the particles and can if necessary additionally occur in the pulse intervals.

In a particularly advantageous manner, in step c of the method according to the invention, the particles partially dissolve and in step b, the dissolved material is deposited as a matrix material at the same time as the particles. This results in the advantage that the matrix material, in contrast to a deposition in the pulse intervals, is not deposited in a separate layer adjacent to a layer consisting of particles, and thus no heterogeneous layer stack is created. To a far greater extent, a mixing through takes place, so that at least a portion of the particles is surrounded by matrix material, and the particles are preferably embedded in the matrix material.

In further embodiments, it is preferred that further substances are added to the suspension which positively influence the electrochemical properties of the matrix material. These include for example those substances which if required dope the matrix material in such a manner that the type of majority charge carrier of the matrix material corresponds to the type of minority charge carrier of the particles. Suitable additives include metal halides, particularly metal chlorides.

Further preferred embodiments of the invention are described in the remaining features given in the subclaims.

The various embodiments of the invention named in this application can, unless otherwise stated in individual cases, be advantageously combined with each other.

The invention will now be explained below in exemplary embodiments with reference to the appended drawings, in which:

FIG. 1 shows a schematic profile view of an electrode for photoelectric catalysis according to the prior art (I) and in a preferred embodiment of the invention (II),

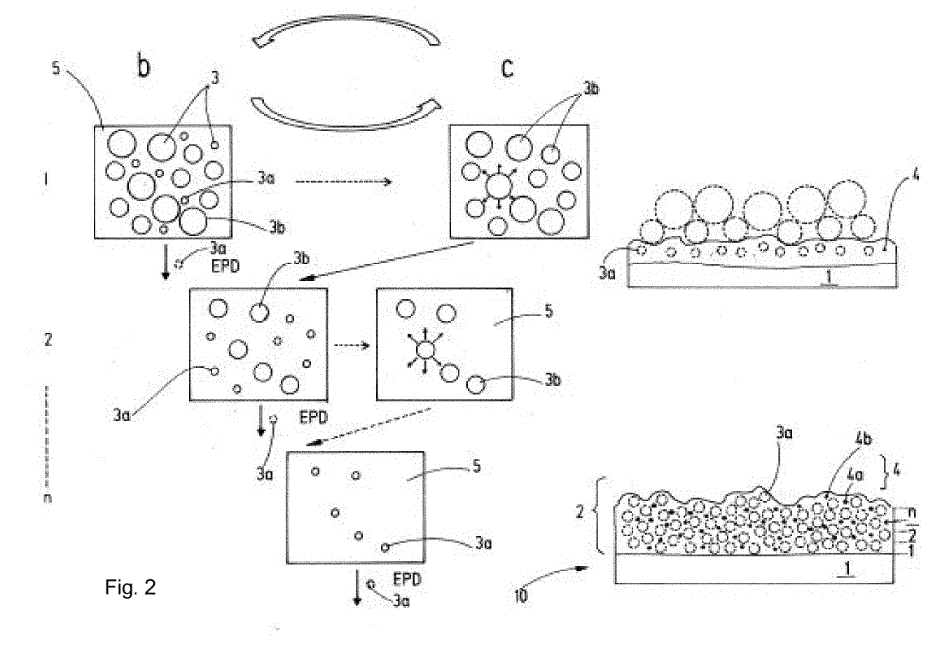

FIG. 2 shows a schematic view of the method according to the invention in a preferred embodiment,

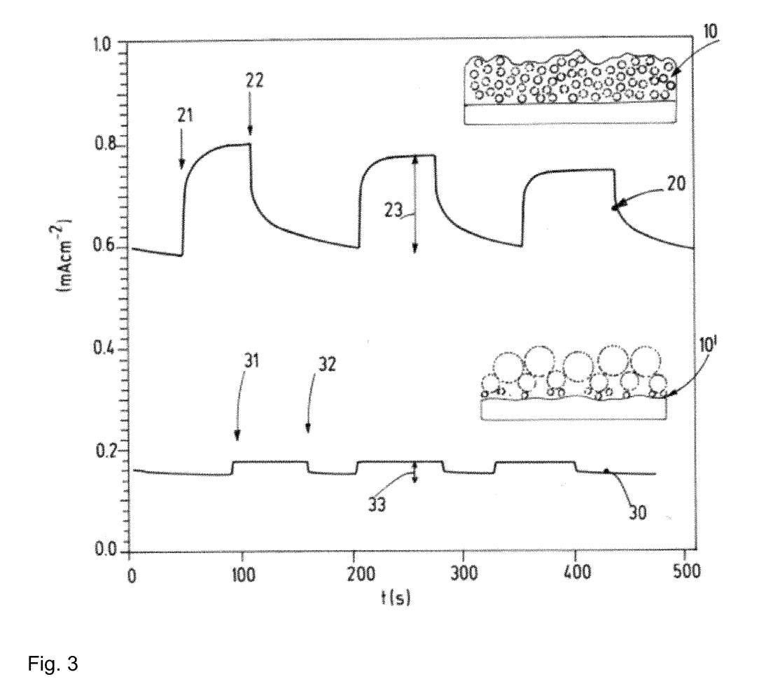

FIG. 3 shows a diagram of the photocurrent densities of an electrode according to the prior art and of an electrode according to the invention as a comparison, and

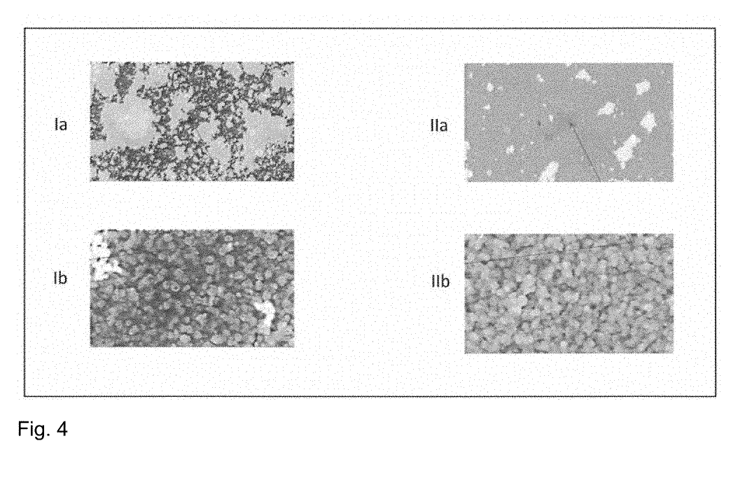

FIG. 4 shows EDX images of an electrode produced using the method according to the invention in two resolutions.

FIG. 1 shows a schematic profile drawing of an electrode 10′ according to the prior art (partial view I) compared to an electrode 10 according to the invention (partial view II). Both electrodes, 10, 10′ feature a supporting layer 1 on which a catalytic layer 2 is deposited, which for its part comprises photoactive particles 3. The electrodes 10, 10′ can for example be represented using electrophoretic deposition (EPD).

The structure of the electrode 10′ as is typically maintained from the electrophoretic deposition of particles 3 with a larger diameter distribution, features in the catalytic layer 2 both smaller particles 3a and larger particles 3b. In accordance with the respective mobility of the particles 3 during the deposition in the solution, the smallest particles 3a are deposited fastest, while the larger particles 3b are deposited slowest. For this reason, smaller particles 3a are arranged closer to the supporting layer 1 than the larger particles 3b.

The partial depiction II of FIG. 1 shows the structure of the electrode 10 according to the invention, in which small particles 3a (diameter<diffusion length) are arranged monodispersed in several layers 5 on the supporting layer 1, while an embedded (amorphous) matrix 4, which comprises an amorphous electronic and electrochemically inert base material 4b and an amorphous semiconductor material 4a permits the removal of light-generated charge carriers through to the electrolyte interface. The inert base material 4b is particularly carbon-rich (carbon share higher than 30% weight, in particular higher than 50% weight), while the semiconductor material 4a, such as a metallic oxide, with a carbon share of less than 30% weight, in particular less than 20% weight, features a cation which corresponds to a cation of the photoactive particles 3a. Here, it is irrelevant whether the cations of the particles 3a and those of the semiconductor material 4a of the matrix feature the same oxidation stage.

With the electrode according to the invention, charge carriers are generated in the particles 3a which move from there through the matrix 4 starting within the semiconductor material 4a of the matrix 4 via what is known as a hopping mechanism. The inert base material 4b presents a high-impedance barrier for the charge carriers, which they can only cross via a tunnel effect. In order to realize good conductivity in spite of this, the expansion of the base material 4b and/or the distance between electrically conductive and semi-conductive particles 3a, 4a is as low as possible, preferably in a region of 1 to 5 nm.

A photoelectric electrode for photoelectric catalysis according to the invention uses coupled electron and ion transport for catalytic energy conversion. Here, the electrolyte takes on the role of the ion conductor. In this electrolyte, partially irreversible chemical processes take place such as the splitting of H₂O into H₂ and O₂. The same electrode can now be operated in a comparable arrangement, in which the electrolyte, which is indeed not an object of the invention, is replaced by one that contains a so-called redox pair such as iodide/tri-iodide. The arrangement realized as a result converts light energy into a photovoltage and a photocurrent under reversible conditions (I⁻→I₃⁻ and I₃⁻→I⁻), without consuming the electrolyte. This is then a photoelectrochemical solar cell. In a further embodiment, the electrolyte can be fully replaced by an electron conductor, which connects the electrode to the counter-electrode. This can occur through direct contacting of the surface with an electrically conductive, in particular metallic, material and/or through deposition of a transparent conductive oxide (TCO), which for its part is preferably connected via metallic contacts to the counter-electrode. Through this arrangement, a solid body solar cell is realized in which the required photovoltage and the photocurrent are generated in the structures known as catalyst particles.

FIG. 2 shows a schematic view of the method according to the invention in an n-step electrophoretic deposition of commercially available particles 3 with a large diameter distribution. Initially, the particles 3 which vary strongly in relation to the particle diameter, are suspended in a solvent 5 (not shown). The suspension is brought into contact with a supporting layer 1. This can occur both before and after the suspension. Subsequently, the deposition process begins, which generally occurs in two steps (b, c) which are repeated until the desired layer thickness of the catalytic layer 2 is achieved.

With the multi-stage deposition here according to the invention, the interim etching of the particles (c) and brief electrophoretic deposition phases (b) realize a homogeneous size distribution on the carrier material 1, while the reaction products of the etching process enable an embedding structure of the matrix material 4. In individual cases, with the addition of further additives, the chemical composition of the matrix material and its electronic properties can be suitably modified, so that favorable conductivity properties for the charge transport and interface deflections can be realized.

In a preferred embodiment, this specifically means the following:

1) Pigment particles are suspended in a solvent which is suitable for an electrophoretic deposition (e.g. acetone or acetonitrile). The surface charge of the particles 3 is determined by the addition of a suitable reduction or oxidation agent (e.g. Iodine), so that a uniform transportation to the supporting layer 1 with the opposite charge is guaranteed. Via a brief voltage pulse, only the smallest particles 3a (with diameters smaller than the diffusion length, if already present in the suspension) are electrophoretically deposited on the carrier material. This effect is realized by the fact that larger particles (with a larger diameter) require longer transport times in the viscous solution due to the higher resistance (the resistance increases quadratically with the diameter).

2) Through the addition of a chemical etching agent, the particle diameters are subsequently reduced, whereby areas of the particles 3a that are close to the surface dissolve (shown here with small arrows). At the same time, due to the etching (c), a particle surface is realized that features a lower density of surface states. In general, acids or lyes are suitable for this purpose. When iodine is used, however, the protic, i.e. proton-providing ethanol, can be added in order to achieve an acidic and thus slightly etching effect. During the course of this etching (c), material of the particles (3) is released into the suspension. A subsequent voltage pulse in turn transports the smallest particles 3a to the supporting layer 1. Simultaneously, the matrix 4 is formed electrochemically on the electrode, which during the course of etching is compiled from the chemical components of the reaction products that have dissolved. This matrix material 4 features e.g. an amorphous structure. If necessary, further chemical additives (e.g. Metal chlorides) can serve to modify the electronic properties of the matrix material 4.

3) Steps 1 and 2 are repeated until the desired film thickness on the electrode has been realized. If an exhaustion of the iodine concentration occurs before the film thickness is achieved, iodine is preferably again added to the suspension. This exhaustion of the iodine concentration can alternatively or additionally serve as an indicator and/or regulator for the deposition. The entire light absorption behavior and thus the rate of incoming light to generated charge carriers is determined via the film thickness (incident photon to charge carrier efficiency. IPCE).

### Exemplary Embodiment

Bismuth vanadate pigments (BiVO₄) (from Bruchsaler-Farben GmbH) were used. The yellow pigments (35 mg) are according to step a of the method according to the invention suspended in an acetone (10 ml)/iodine (40 mg) solution in an ultrasound bath (37 kHz) for 10 minutes. Subsequently, the suspension for the electrophoretic deposition was electrophoretically deposited on a carrier (fluorinated tin oxide, FTO) with triple repetition for 1 minute and 40 seconds respectively. Between the individual depositions, the suspension was again set in the ultrasound bath. Since the added iodine forms the acetone solution together with residual water, a strong partial dissolution of the oxidic particles and thus a reduction in size is achieved. The resulting surface morphology was determined using EDX following the first and final deposition (FIG. 3) and corresponds to the electrode 10 shown schematically in FIG. 1 II.

In the example selected here, the matrix material 4 is primarily amorphous vanadium oxide (VₓO_{y}) which embeds the particles 3 consisting of BiVO₄.

In FIG. 3, the behavior of the two electrodes 10, 10′ is shown in comparison with a constant potential (1.2 V) and a light switched on or off (approx. 50 mWcm−2). The points in time of the switching on or off of the light are shown with reference numerals 21 and 22. While the electrode 10′ according to the prior art (which can be produced for example through one-off electrophoretic deposition of a solution until the desired layer thickness is achieved) only features photocurrent densities of approximately 20 μAcm⁻² during the light pulse, the electrode 10 according to the invention achieves photocurrent densities of up to 200 μAcm⁻². The results were determined during the photoelectric generation of oxygen in a 0.1M NaOH electrolyte. The photocurrent response of the two compared electrodes 10, 10′ is shown in a 0.1M NaOH electrolyte. As a potential, 1.2 V was selected in comparison with an Ag/AgCl reference electrode.

FIG. 4 shows EDX images of the catalytic layer on the interface of the matrix material after step 1 (I) and at the same site in the matrix material following completion of the method according to the invention represented in FIG. 3 (II). In the overview (Ia) a (thinner) interface surface can be seen which is partially covered by larger particles or particle agglomerates. The amorphous phase in Ib shows smaller particles that are hardly embedded at all. By contrast, the overview IIa of the EDX image following completion of the method (II) shows a reduction in deposited larger particles or agglomerates. The detailed view IIB shows a nanoparticular heterolayer consisting of small individual constituents, surrounded by an amorphous phase. In IIb, a nanoparticular heterolayer can clearly be seen consisting of small (non-crystalline) individual constituents, which are surrounded by an amorphous phase. Here, the nanoparticular, non-crystalline constituents form the matrix material together with the amorphous phase.

### LIST OF REFERENCE NUMERALS

1 Supporting layer
2 Catalytic layer
3 Particles
3a Small particles
3b Larger particles
4 Matrix
4a Amorphous semiconductor material
4b Inert base material
5 Solvent
10 Electrode
10′ Electrode according to the prior art
20 Power density of an electrode according to the invention
30 Power density of an electrode according to the prior art
21/31 Light on
22/32 Light off
23/33 Photocurrent density

1. An electrode (10) for photoelectric catalysis, comprising a supporting layer on which a catalytic layer is arranged, which comprises particles from a first semiconductor material, characterized in that the catalytic layer further features a matrix from an amorphous material which at least partially surrounds the particles.

2. The electrode for photoelectric catalysis according to claim 1, characterized in that at least 90% of the particles feature a deviation from an average particle diameter of maximum 20%, in particular of maximum 10%.

3. The electrode for photoelectric catalysis according to claim 1, characterized in that the semiconductor materials feature free charge carriers, wherein the type of charge carriers that represent a majority in the matrix material corresponds to the type of charge carrier that form in the particles as a result of the illumination.

4. The electrode for photoelectric catalysis according to claim 1, characterized in that the catalytic layer is formed as a multilayer system.

5. The electrode for photoelectric catalysis according to claim 1, characterized in that the electrode is a photoelectrochemical or a photovoltaic electrode.

6. The electrode for photoelectric catalysis according to claim 1, characterized in that an ion conductor, in other words, an electrolyte or an electron conductor, is arranged on the electrode.

7. A solar cell featuring an electrode for photoelectric catalysis according to claim 1 and an ion conductor, in other words an electrolyte or an electron conductor.

8. The solar cell according to claim 1, characterized in that the solar cell further comprises an in particular transparent counter-electrode, and the electrode for photoelectric catalysis is connected to the counter-electrode in an electrically conductive manner via the ion conductor.

9. A method for producing an electrode for photoelectric catalysis, comprising the following steps:
a: Preparing a suspension of particles in a solvent and bringing the suspension into contact with a supporting layer,
b: Applying a voltage pulse between the supporting layer and the suspension for depositing a layer of particles on the supporting layer, and
c: Reducing the diameter of the suspended particles, and
single repetition of step (b) or multiple repetition of steps (b) and (c).

10. The method according to claim 9, characterized in that the voltage pulse is applied for a time duration ranging from 10 seconds to 5 minutes.

11. The method according to claim 9, characterized in that the particle diameter is reduced using chemical etching.

12. The method according to claim 9, characterized in that during step (c) of the method, no voltage, or a lower voltage than in step (b), is applied between the supporting layer and the suspension.

13. The method according to claim 9, characterized in that a surface charge of the particles is determined through the addition of an oxidation or reduction agent to the suspension.

14. The method according to claim 9, characterized in that in step (c), the particles partially dissolve and in step (b) the dissolved particle material is deposited as a matrix simultaneously with the particles.
